(19) United States
(12) Patent Application Publication
(10) Pub. No.: US 2006/0233600 A1
(43) Pub. Date: Oct. 19, 2006

(54) Corner joint and method for producing a joint of this type

(76) Inventors: Jurg Egli, Kesswil (CH); Michael Leitner, Lauterach (AT)

Correspondence Address: SHOEMAKER AND MATTARE, LTD, 10 POST OFFICE ROAD - SUITE 110, SILVER SPRING, MD, 20910, US

(21) Appl. No.: 10/568,675

(22) PCT Filed: Aug. 18, 2004
(86) PCT No.: PCT/EP04/09261

§ 371 Date: Jun. 14, 2006

(30) Foreign Application Priority Data
Aug. 18, 2003 (EP) 03405601.0

(51) Int. Cl. F16B 12/36

(52) U.S. Cl. 403/294

(57) ABSTRACT

A corner joint includes two connecting parts, which are fixed to the respective hollow sections. The mitered hollow sections and the fixed connecting parts are interconnected by screws in such a way that the hollow sections can be braced against one another. Recesses and/or distribution channels for receiving and distributing adhesive are provided on at least one lateral surface of a connecting part.

The invention relates to a corner joint consisting of a corner connector and two metal sections and also to a method for producing such a joint with the features of the preamble of the independent claims. The invention also relates to a connecting part of which the corner connector composed of at least two connecting parts consists.

Numerous corner joints or corner connectors are already known and in use. For example, EP 0 810 344 B1 describes a corner joint which uses an approximately L-shaped one-piece corner connector for connecting mitered hollow sections.

EP 0 810 344 B1 itself describes a corner connector and associated mitered hollow sections, the sections being pressed together by fastening arrangements which are supported on the corner connector. The hollow sections are additionally glued together with the corner connector.

DE 86 21 143 U discloses a device and a method in which hollow sections are connected to form a corner joint with the aid of a connecting piece.

It has been found in practice that the production of a corner joint with the aid of a one-piece corner connector is comparatively difficult depending on the purpose for which it is to be used. Furthermore, the known methods are not very suitable for pressing the sections against one another in a way which is reliable and easy to bring about.

Two-part corner connectors are known from FR 2 477 443, for example. The corner joint in FR 2 477 443 consists of mitered hollow sections into which a corner connector part can in each case be introduced. Screwed connections above all are customary for connecting the corner connector parts to the hollow sections and the corner connector parts to one another.

FR 86 645 discloses a corner joint in which frame sections open on one side are interconnected. In this case, the corner joint parts can be arranged offset inwardly on the sections, by virtue of which a distance is defined between the miter surfaces of the corner connector parts.

A corner joint with a corner connector consisting of two connecting elements, two reinforcing sections and two mitered hollow sections made of plastic is also known from EP 1 333 145 A2. There, a connecting element can in each case be introduced into a reinforcing section and the latter can in each case be introduced into a hollow space of a hollow section. The connecting elements are connected to the hollow sections by screws and to one another likewise by screws. The screws for connecting the connecting elements to the hollow sections on the one hand and for connecting the connecting elements to one another on the other hand are tightened stepwise in such a way that the hollow sections are pressed against one another. The plastic hollow sections are then welded together with one another.

FR 2 729 738 A1 discloses a corner joint with two prism-shaped corner connector parts. The connection arrangement is effected essentially with the aid of screws, gluing locations also being provided.

Corner joints which comprise exclusively glued connections are also known. DE 101 18 791 A1 for instance discloses a corner joint for hollow sections made of aluminum with an L-shaped connecting element into which adhesive can be filled via channel-forming recesses and chambers.

DE 198 18 632 A1 relates to a corner joint for hollow plastic sections. Corresponding inserts made of plastic can in each case be inserted into the mitered hollow sections. The insert bodies have an adhesive channel guide system for connecting the insert bodies to the hollow sections, adhesive being introduced via an inlet opening in the region of a miter surface of an insert body.

It is therefore an object of the present invention to avoid the disadvantages of the known art, in particular to produce a device and a method of the kind mentioned in the introduction, which device is characterized by simple, economical use, great stability and a wide range of applications. The corner joint is to be especially well-suited for metal hollow sections.

According to the invention, these objects are achieved with a corner joint, a connecting part and a kit for this corner joint and also a method for producing a corner joint with the features of the characterizing part of the independent claims.

A corner joint for frames of wall elements, doors or windows comprises a corner connector and mitered hollow sections. The corner connector is in this connection composed of at least two parts. The connecting parts can in each case be introduced into a hollow space of a hollow section and comprise a fastening arrangement for connection to in each case a hollow section. The connecting parts also have a connecting arrangement for connecting the connecting parts each fastened to a hollow section to one another. As the connecting parts are in each case premounted in the respective hollow sections, the hollow sections (with their associated connecting parts) only have to be positioned in relation to one another and then joined together by connecting the connecting parts for the actual connection of the corners. The comparatively complicated working step of inserting the respective legs of a one-piece corner connector of the abovementioned known kind is consequently dispensed with. The two-part construction of a corner connector consequently has great advantages as far as handling and assembly of a corner joint are concerned. The connecting parts can also be produced relatively cost-effectively in comparison with L-shaped parts.

The hollow sections are usually made of metal material, in particular steel, from which relatively complicated cross sections can also be produced. In this connection, the metal is rolled or drawn for example. Production can also take place by extrusion. The hollow section is in its simplest form of essentially rectangular design in cross section. Hollow sections can of course also have other shapes or geometries. In particular, the connecting parts are also suitable for use in sections which, instead of only one hollow space, have a number of hollow spaces which are separate from one another and run parallel. The associated connecting parts in each case are designed in cross section in such a way that they can be inserted with an exact fit into a hollow space of the section without or at least with only a small amount of play. The connecting parts themselves are likewise as a rule made of metal material, preferably steel, special steel or aluminum. The connecting arrangement for connecting the connecting parts each fastened to a hollow section and/or the connecting parts are designed in such a way that the mitered hollow sections are pressed against one another under prestress during the connection operation. The result of this is that any production-related unevenness or inaccuracy of the mitered sections in the region of their miter are compensated for.

The stability of the corner joint is also improved by the frictional connection. A further advantage is that the corners meet higher aesthetic requirements by avoiding any gaps.

Recesses and distribution channels for receiving injectable adhesive are provided on at least one boundary surface of a connecting part. In this connection, a boundary surface is a surface of the connecting part which bears against the hollow section inner wall. Adhesive can thus be applied in accurately defined areas. This also has the advantage that adhesive can be saved as the entire surface is not intended for receiving adhesive. An injectable adhesive can be distributed effectively with the aid of the distribution channels.

The connecting parts are especially advantageously provided with a miter, the miter angle corresponding approximately to that of the respective associated hollow sections. The miter surfaces of a hollow section and the miter surface of the respective connecting part consequently run parallel to one another. This has the advantage that the connecting parts or hollow sections are pressed against one another uniformly and consequently no stress peaks can arise.

At least one of the connecting parts is especially advantageously fastened at a distance from the miter surface of a hollow section. During connection of the hollow sections, or the connecting parts fastened thereto, to one another, the distance between the miter surfaces of the connecting parts is reduced, by virtue of which the hollow sections are pressed against one another in the region of the miter. This arrangement of the connecting parts in the hollow sections has the advantage that the hollow sections can be pressed against one another under prestress in a simple way. Through the choice of distance, it is possible to adjust the desired pressing force or prestress to a certain degree. However, the connecting parts are preferably fitted into the respective hollow sections at the same distance.

In a further illustrative embodiment, the respective hollow section and the respective connecting part can be screwed and/or glued together with one another. The connection between hollow section and the respective connecting part can thus be brought about relatively simply. In order to keep the effort required for assembly as small as possible, only a few, for example two, screws are advantageously used per hollow section in each case, which screws are in particular countersunk on the same surface of the hollow section. A screwed connection likewise has the advantage that the abovementioned distance can be set in a simple way by means of the positioning of the screwed connection. On the other hand, a glued connection has the advantage that the section does not have to be provided with a number of unsightly bores. A combination of the connection types gluing and screwing results in a particularly firm connection. Gluing can also simply serve for additionally securing the screwed connection.

The connecting part is especially advantageously fastened to the hollow section by means of self-tapping screws. This has the advantage that the connecting part does not have to comprise a screw thread, but simple drill holes are sufficient. The comparatively involved working step of providing a thread, for instance thread-cutting, can thus be dispensed with in the production of a connecting part. As a result, a connecting part can be produced more simply and less expensively.

In a following illustrative embodiment, connecting parts are screwed and/or glued together with one another. This allows the corner joint to be assembled easily. Gluing is effected by, for example, the connecting parts being coated with adhesive on their miter surface. A combination of gluing and screwing has the advantage moreover that—in comparison with gluing alone—additional holding or positioning means for accurate positioning of the connecting parts or the hollow sections connected thereto with one another can be dispensed with.

The connecting parts comprise especially advantageously at least one through-bore running at right angles to the miter for connecting the connecting parts. With the aid of this through-bore, the connecting parts can be screwed together with one another simply with fastening screws. The screws are introduced into the through-bore from one side and then tightened with the aid of a nut or a corresponding thread in the opposite connecting part. This has the advantage that pressing of the hollow sections against one another can be brought about easily by tightening the screwed connection.

According to a further illustrative embodiment, the connecting parts have a recess for receiving a nut in the inlet region of the through-bore. This arrangement makes it possible to insert receiving nuts therein. A user can thus choose from which side, or from which of the hollow sections of a corner joint, a fastening screw is to be introduced. Assembly of a corner joint can thus be made flexible. In particular, this makes assembly of frames for wall elements, doors or windows which is adapted to the constructional circumstances possible, for example. The receiving nuts can already be inserted before the first production step, the fastening of the connecting parts to the respective hollow sections. These nuts are secured rotationally by, for example, gluing the nuts in the blind hole or by positive and/or frictional connection.

It is particularly advantageous if the hollow section comprises at least one opening for the injection of adhesive into the distribution channels. This makes it possible to introduce adhesive between hollow section and connecting section from only a few injection openings. It is thus possible to assemble the corner joint entirely mechanically first, for example with the aid of screwed connections, and only then additionally to introduce adhesive. The handling and use of adhesive is simplified. The process of producing a glued and screwed corner joint can be made considerably more efficient.

According to a further illustrative embodiment, the connecting part comprises webs and recesses running in the longitudinal direction in the region of the outer side and in the region of the inner side. In this connection, inner side means the inner face of a frame corner. Consequently, outer side means the opposite, outer face or that side of a mitered hollow section which has the greatest length owing to mitering. The connecting part is produced by cutting machining, for example in a milling station. However, it is also possible to make the connecting part in the form of a cast part. The form of the connecting parts brings about a weight reduction without the connecting parts losing their functional or static characteristics.

In an illustrative embodiment which is especially advantageous for this, the connecting part comprises a central recess in the region of the outer side and, corresponding to this, two webs at the side and also at least one web in the region of the inner side. The space created by the central recess can be used, for example, for running electric wiring and a lock closing bar through inside the corner joint. It is also possible for sealing or insulating material to be introduced into the recesses.

The corner joint can be produced by means of the following steps: each connecting part is connected to a respective hollow section with the aid of a fastening arrangement, and the connecting parts each fastened to a hollow section are then connected to one another with the aid of a connecting arrangement. Accordingly, the production operation consists essentially of two steps.

The mitered hollow sections are especially advantageously pressed against one another in the second step during connection of the connecting parts each fastened to a hollow section.

This pressing can be brought about by the connecting parts in each case being introduced into the hollow sections and fastened in such a way that a distance is present between the miter surfaces of a hollow section and of the respective connecting part. When the connecting parts are then connected to one another for the connection of the hollow sections, the gap which is present owing to the distance mentioned is reduced by the connecting parts being drawn together, so that the hollow sections are pressed against one another in the region of the miter.

Further individual features and advantages of the invention emerge from the description below of illustrative embodiments and from the drawings, in which:

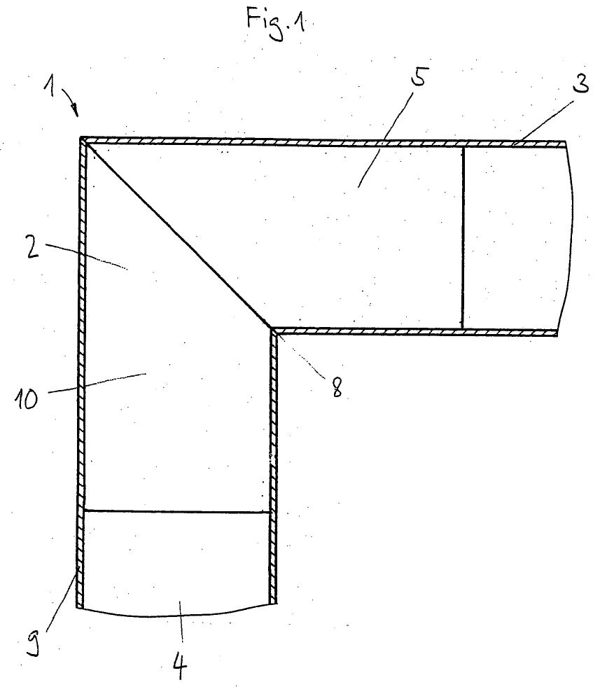

FIG. 1 shows a diagrammatic side view of a first illustrative embodiment of a corner joint according to the invention;

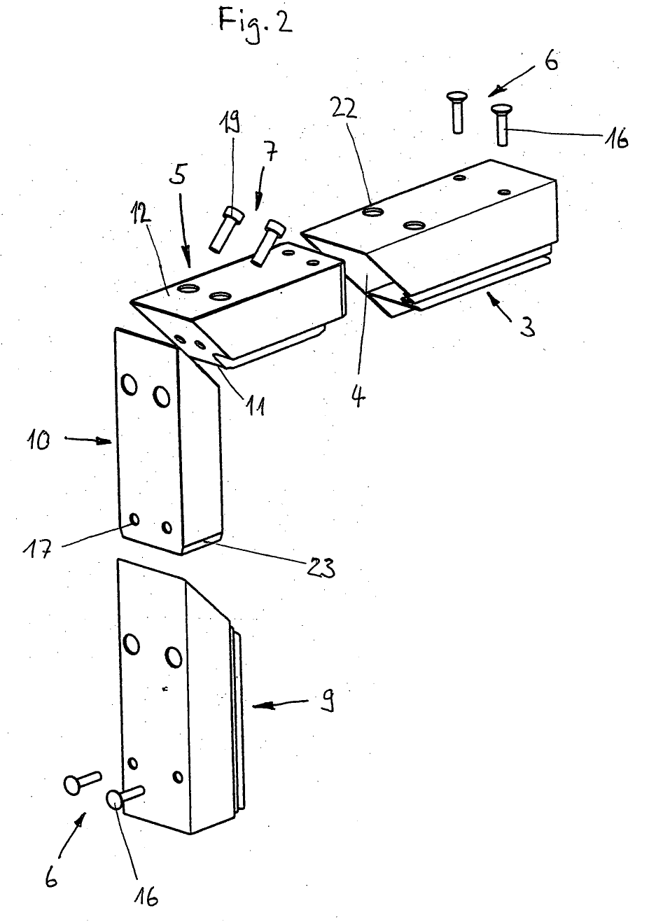

FIG. 2 shows a perspective exploded illustration of a corner joint;

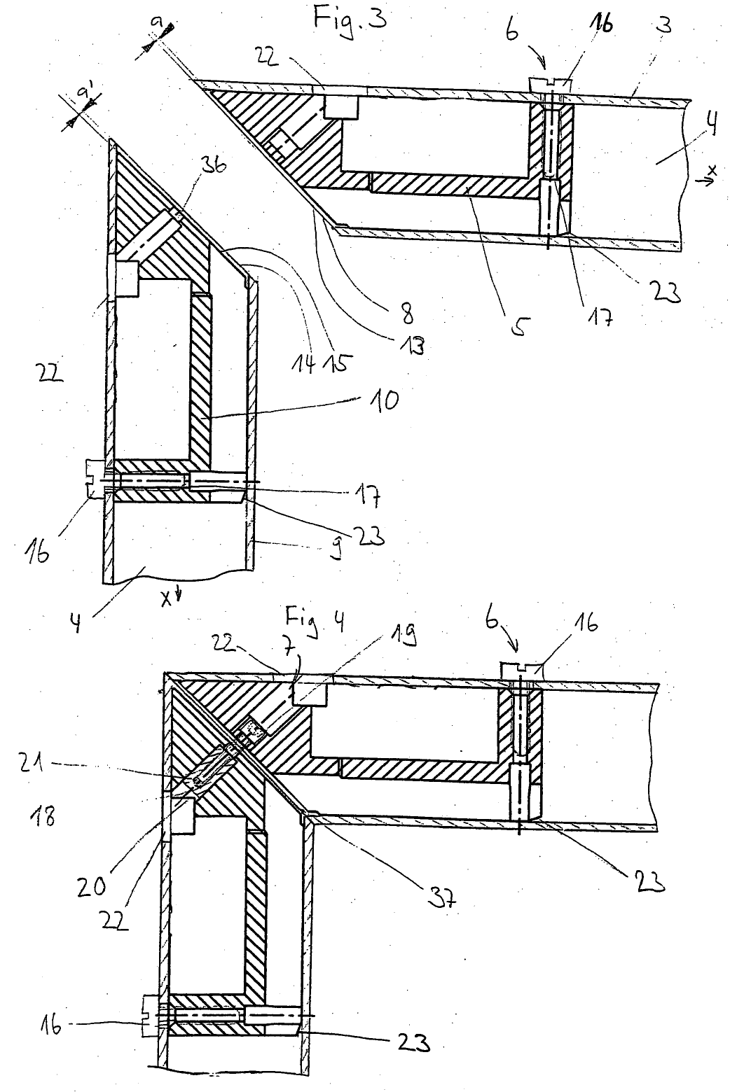

FIG. 3 shows a longitudinal section through two connecting parts, each connected to a hollow section, before assembly;

FIG. 4 shows a longitudinal section through a corner joint, the corner joint having been produced by assembling the connecting parts with the hollow section fastened thereto according to FIG. 3;

FIG. 5 shows a longitudinal section through a corner joint according to a further illustrative embodiment;

FIG. 6 shows a section through a connecting part and a hollow section from FIG. 5 (section B-B);

FIG. 7 shows a top view from the outer side of a connecting part according to the illustrative embodiment from FIG. 5;

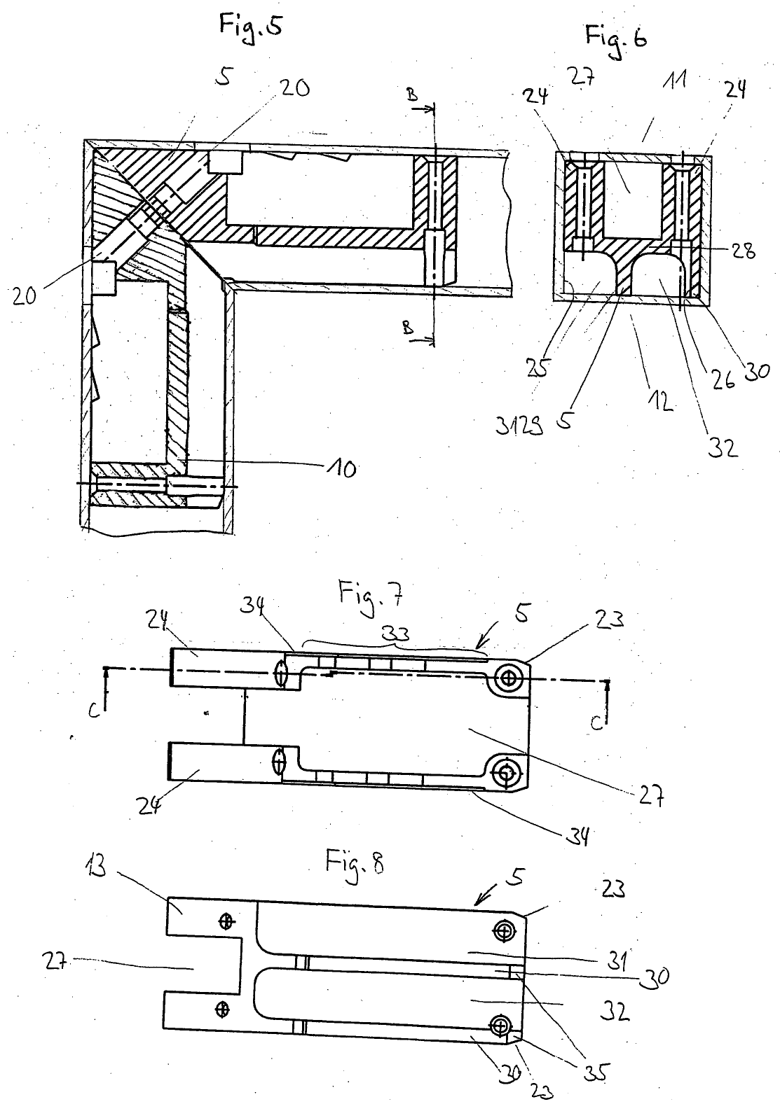

FIG. 8 shows a top view from the inner side of a connecting part according to the illustrative embodiment from FIG. 5;

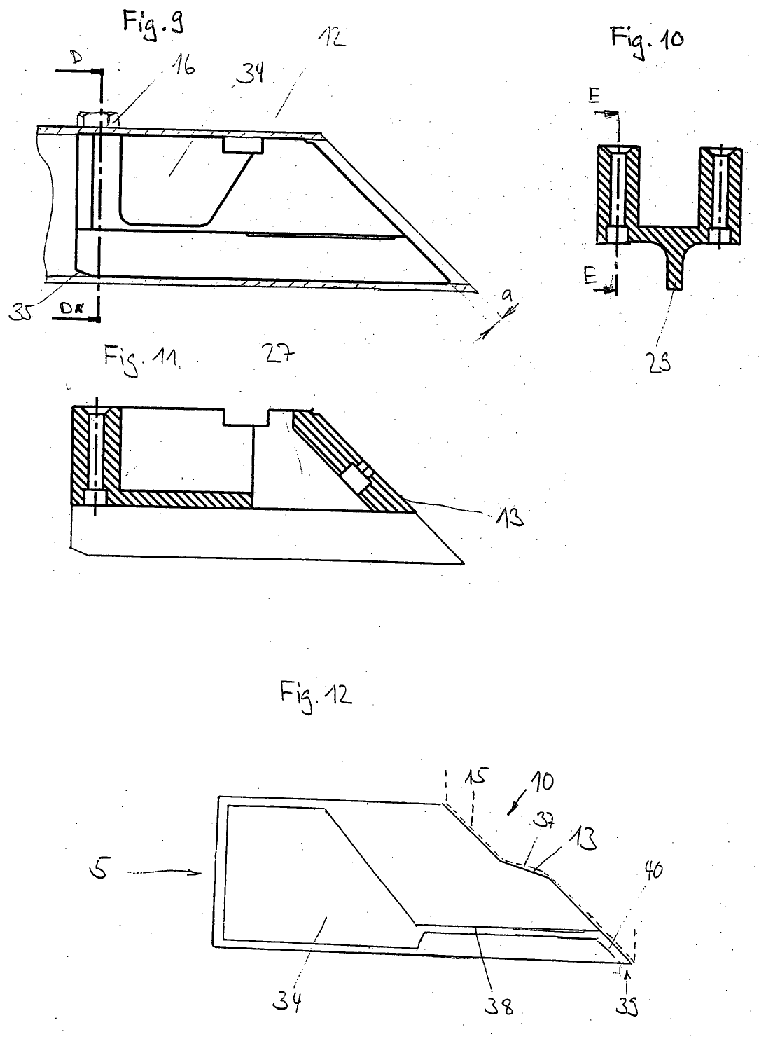

FIG. 9 shows a side view of a connecting part according to a further illustrative embodiment, which is fastened in a hollow section;

FIG. 10 shows a section through a connecting part according to the illustrative embodiment from FIG. 9 (section DD);

FIG. 11 shows a longitudinal section through the connecting part according to the illustrative embodiment from FIG. 9; and

FIG. 12 shows a side view of a connecting part according to a further illustrative embodiment.

As can be seen from FIG. 1, a corner joint consists essentially of a corner connector 2 and in each case two hollow sections 3, 9. The corner connector 2 is designed in two parts and consists of the connecting parts 5 and 10. In the present diagrammatic illustration (as in all the following figures), the angle of the miter surface 8 of the mitered hollow sections 3, 9 is to be 45° to the longitudinal axis. Other angles are also conceivable, however, one of the hollow sections being mitered at an angle of 60°, for example, and the other at an angle of 30°. However, this then presupposes hollow sections with different cross sections. The miter angle of the associated connecting parts 2, 5 concerned is adapted accordingly.

The perspective exploded illustration according to FIG. 2 shows details for a corner joint 1. The respective connecting parts 5, 10 are inserted into the respective hollow sections 3, 9. In their simplest form, the shape and dimensions of the connecting parts 5, 10 correspond to those of the hollow space 4 of the hollow sections 3, 9, and in this case they are rectangular. The connecting parts 5, 10 can be introduced into the hollow sections 3, 9 with approximately an exact fit. The hollow sections are as a rule produced by extrusion. The finishing accuracy of the hollow sections plays a role inasmuch as it has to be taken into consideration in the design of a connecting part. Play-free insertion is guaranteed only with high finishing quality of the sections. More complicated geometries are of course also conceivable instead of a rectangular cross section; the requirement is only that the connecting part 5, 10 can be introduced positively into the hollow section 3, 9. After insertion, the connecting parts 5, 10 are fastened to the respective hollow section 3, 9, for example with the aid of fastening screws. Other fastening means, such as riveting, gluing or welding for example, are also possible.

FIGS. 3 and 4 show how the hollow sections 3, 9 with the connecting parts 5, 10 fastened thereto are connected to one another. For this, the respective connecting parts 5, 10 are inserted into the respective hollow sections 3, 9 in the x direction into a predefined position. The connecting part 5, 10 has a bevel 23 which ensures that the connecting part 5, 10 can be introduced more easily into the hollow space 4 of a hollow section. In the present illustrative embodiment, the connecting parts 5, 10 are inserted to such an extent that a distance a, a′ is present between the miter surface 13, 15 of the respective connecting parts and the miter surface 8, 14 of the hollow sections. The distance a or a′ is approximately 0 to 2 mm, preferably 0.5 mm to 1 mm. The distance to be chosen depends in particular on the dimensions of the hollow sections. The distances a and a′ are as a rule the same. For uniform force distribution, the respective miter surfaces 8, 13 and 14, 15 of the hollow sections and connecting parts must lie parallel to one another. The connecting parts 5, 10 are fastened to the respective hollow section 3, 9 in the predefined position, for instance by means of fastening screws 16 as in the present case, for example a slotted screw 16. The fastening screw 16 is especially advantageously designed as a self-tapping screw, so that a thread does not have to be cut into the connecting part 5, 10. A simple through-bore 17 is sufficient. This has the advantage that one working step is dispensed with for the production of a connecting part 5, 10. Other types of fastening are also conceivable, for instance with the aid of nails or pins; in particular, the connecting part 5, 10 can be glued into the respective hollow section 3, 9, for example with a PU or silicone adhesive. It is particularly advantageous if the miter surfaces are glued together in addition to being screwed together. For this, the miter surfaces can be coated with adhesive before screwing together. It is also possible, however, for injectable adhesive to be introduced, after insertion of the screws but preferably before tightening of the screws, into the hollow space 37 created by the distances a, a′ via a single opening (not included in the drawing) in the region of the miter. It is also possible furthermore for at least one miter surface 13, 15 of a connecting part 5, 10 to comprise recesses for receiving adhesive.

FIG. 4 shows the assembled corner joint 1. The hollow sections 3, 9 and the connecting parts 5, 10 fastened thereto are positioned in relation to one another in such a way that a corner is produced. The two parts are then joined together by means of a screwed connection. In this respect, the central axis 18 of the screwed connection is at right angles to the miter surface 13 or 15 of a connecting part 5, 10. In the illustrative embodiment in FIG. 4, the screw 19 is in the form of a hexagon socket screw for better accessibility for a tool for tightening the screw. A nut 21, which forms the counterpart for the screw 19, is let into an inlet opening 20 in the region of the through-bore 17. The nut 21 can be glued firmly in the corresponding blind hole. The nut 21 can also be in the form of a rivet-in nut. The nut 21 is thus rotationally secured. Other arrangements are also possible. It is also conceivable, however, for a corresponding thread to be present in the respective connecting part. It can be advantageous if the corner joint is glued together in addition to the screwed connection. For this, the miter surfaces 13, 15 of the connecting parts 5, 10 are coated with adhesive. This also has the advantage that, owing to the connecting parts 5, 10 being set back at a distance a or a′ in relation to the respective hollow sections 3, 9, no adhesive can force its way to the outside. It is furthermore possible for the respective connecting parts 5, 10 to be simply glued together with the associated hollow sections 3, 9 instead of using a screwed connection, the connecting parts 5, 10 being pressed against one another with the aid of a pressing device not described here, as a result of which their miter surfaces 13, 15 form a glued connection. For assembly, or introduction of the fastening means 19, 21, a cutout 22 which ensures that these fastening means can be introduced is located on the outer side of the hollow section 3, 9. As shown in FIG. 5, the two connecting parts 5, 10 are of the same design, in particular the bores provided for the screwed connection for connecting the connecting parts to one another. This has the advantage that it is possible to choose according to the intended use from which side a screw 19 is to be introduced; the user therefore has the choice of introducing a screw 19 either from the inlet opening 20 of the “right” or via the inlet opening 20 of the “left” connecting part 10. If space conditions are difficult, the receiving nut 21 can already be introduced into that connecting part considered of difficult access owing to the space conditions before the connection of the connecting parts to the respective hollow sections. This ensures that corner joints can also be assembled in tight space conditions, which increases the flexibility and range of application of the corner joint.

FIG. 6, which illustrates a section through the connecting part 5 and the hollow section 3 in the region of the fastening device for connecting the connecting part 5 to the hollow section 3 (section B-B), again shows clearly that a positive connection exists between connecting part 5 and hollow section 3. It can likewise be seen that the connecting part 5 does not have to be solid in cross section but can comprise cutouts and recesses. The geometry is selected in such a way that the static characteristics of a corner joint 1 are not (appreciably) influenced. In the region of the outer side 11, the connecting part 5 comprises webs 24 which bear against the inner lateral surfaces 25, 26 of the hollow section 3. Located centrally between the webs 24 is an inner space 27 which can also receive wiring or other accessories. In approximately its central region 28, the connecting part 5 is solid or extends over its entire width (save for the bores provided for the fastening means). The connecting part has a central web 29 in the region of the side facing the inner side 12, a further web 30 in the region adjacent to one lateral surface 26 of the hollow section, and accordingly two hollow spaces 31, 32. The webs 24, 29, 30 are configured in such a way that the dimensions correspond to the hollow space 4 of the hollow section 3.

FIG. 6 also shows that the connecting part 5, 10 has two through-bores 17 for receiving a screw. Depending on the range of application and use, a different number is also conceivable. The through-bore serves for receiving a self-tapping screw which corresponds to it with regard to its diameter. However, through-bolts (and nuts) can of course also be used. In this case, the hollow section would have to have a corresponding bore on its inner side 12.

As FIG. 7 shows, the webs 24 extend over the entire length of the connecting part 5. For weight reasons, they are of narrower design in an approximately central region 33 than in the lateral regions in which fastening arrangements are provided. FIG. 7 also shows recesses 34, which are intended for receiving adhesive, located on the lateral surfaces. The lateral surfaces on which the recesses 34 are arranged form boundary surfaces which bear against a hollow section inner wall, for example the inner lateral surfaces 25, 26 of the hollow section (cf. FIG. 6). It is intended in particular that the recesses 34 can be filled with injectable adhesive.

It can be seen from FIG. 8 that the connecting webs 29, 30 extend over the entire length of the connecting part 5 starting from the miter surface 13. The connecting part 5 also comprises bevels 35 in addition to the lateral bevels 23.

FIGS. 9 to 11 show a further illustrative embodiment of a connecting part 5. This comprises in particular a recess 34 for receiving adhesive in the region of its lateral surface. In contrast to the preceding illustrative embodiment (see FIG. 6), the connecting part 5 has in cross section a single central web 29. This cross section corresponds to a particularly weight-reduced construction without any losses in terms of stability or statics of the corner joint. In contrast to previous illustrative embodiments, the fastening screws 16 are fitted in the present illustrative embodiment.

As FIG. 11 shows, the form of the inner space 27 likewise makes it possible to introduce screws for connecting the two connecting elements 5, 10 to one another from the inner side 12.

FIG. 12 shows that, instead of a straight miter surface, the miter surface can be in the form of a step or steps. The associated miter surfaces 13, 15 of the respective connecting parts 5, 10 are of course to be configured in such a way that they correspond to one another. Such a configuration of a connecting part 5, 10 affords additional advantages as far as stability and robustness of the corner joint 1 are concerned.

FIG. 12 likewise shows a configuration of recesses and distribution channels for receiving adhesive. In the present illustrative embodiment, adhesive can be injected through the opening 39, via the distribution channels 36 and 40 and into the recess 34. The arrangement of the distribution channel in direct proximity to the miter likewise makes it possible to introduce adhesive onto the miter surface 13 of the connecting parts or into the hollow space 37 between them.

1-16. (canceled)

17. A corner joint for frames of wall elements, doors or windows, comprising a corner connector and two mitered hollow sections, wherein the corner connector comprises at least two connecting parts which can be introduced into a hollow space of a hollow section and are each designed with a fastening arrangement for connection to in each case a hollow section, recesses and/or distribution channels for receiving and distributing adhesive being provided on at least one boundary surface of a connecting part, and in that a connecting arrangement for connecting the connecting parts each fastened to a hollow section is provided, connecting arrangement and/or connecting parts being designed in such a way that the mitered hollow sections can be pressed against one another under prestress during the connection operation.

18. The corner joint as claimed in claim 17, wherein the connecting parts are provided with a miter, the miter angle corresponding to that of the respective associated hollow sections.

19. The corner joint as claimed in claim 18, wherein at least one of the connecting parts is fastened in the hollow section at a distance from the miter surface of a hollow section.

20. The corner joint as claimed in claim 17, wherein the respective hollow section and the respective connecting part are screwed and/or glued together with one another.

21. The corner joint as claimed in claim 17, wherein the hollow section is fastened to the connecting part by means of self-tapping screws.

22. The corner joint as claimed in claim 17, wherein the connecting parts are screwed and/or glued together with one another.

23. The corner joint as claimed in claim 17, wherein the connecting parts comprise at least one through-hole, in particular a bore, running approximately at right angles to the miter for connecting the connecting parts.

24. The corner joint as claimed in claim 17, wherein the connecting parts are provided with a nut in the region of the through-hole.

25. The corner joint as claimed in claim 17, wherein the hollow section comprises at least one opening for the injection of adhesive into the distribution channels.

26. The corner joint as claimed in claim 17, wherein the connecting part comprises webs and recesses running in the longitudinal direction in the region of the outer side and in the region of the inner side.

27. The corner joint as claimed in claim 17, wherein the connecting part comprises a central recess in the region of the outer side and correspondingly two webs at the side and also at least one web in the region of the inner side.

28. A connecting part for producing a corner joint as claimed in claim 17 for frames of wall elements, doors or windows consisting of two mitered hollow sections and with at least two connecting parts which can be introduced into a hollow space of a hollow section, wherein the connecting part comprises a miter which corresponds to that of the hollow section to which the connecting part can be connected and a connecting arrangement is provided by means of which two connecting parts with the hollow sections fastened thereto can be connected, the connecting arrangement being designed in such a way that the mitered hollow sections can be pressed against one another under prestress during the connection operation, and in that recesses and/or distribution channels for receiving adhesive are provided on at least one boundary surface of the connecting part.

29. The connecting part as claimed in claim 28, wherein the connecting part comprises as the connecting arrangement at least one through-hole, in particular a bore, for receiving a fastening element, in particular a screw, and in that one of the connecting parts comprises a complementary fastening element, in particular a nut.

30. A method for producing a corner joint for frames of wall elements, doors or windows consisting of a corner connector and at least two mitered hollow sections, the corner connector comprising at least two connecting parts, wherein each connecting part is connected to the respective hollow section with the aid of a fastening arrangement and in that the connecting parts each fastened to a hollow section are then connected to one another with the aid of a connecting arrangement, the mitered hollow sections being pressed against one another under prestress during the connection of the connecting parts each fastened to a hollow section, and in that the respective hollow section and the respective connecting part are screwed and glued together with one another.

31. The method for producing a corner joint as claimed in claim 30, wherein at least one connecting part is connected to the respective hollow section so that a connecting part has a distance from the miter surface of a hollow section.

32. The method for producing a corner joint as claimed in claim 30, wherein the hollow section is fastened to the connecting part by means of self-tapping screws.
